(19) United States
(12) Patent Application Publication
(10) Pub. No.: US 2023/0351457 A1
(43) Pub. Date: Nov. 2, 2023

(54) SYSTEM, METHOD, AND COMPUTER PROGRAM FOR PERSONALIZED CUSTOMER DUNNING

(71) Applicant: RAKUTEN SYMPHONY SINGAPORE PTE. LTD., Capitagreen (SG)

(72) Inventor: Kumeresh KHANNA, Capitagreen (SG)

(73) Assignee: RAKUTEN SYMPHONY SINGAPORE PTE. LTD., Capitagreen (SG)

(21) Appl. No.: 17/789,926

(22) PCT Filed: Apr. 28, 2022
(86) PCT No.: PCT/US2022/026649

§ 371 Date: Jun. 29, 2022

(51) Int. Cl. G06Q 30/04; G06Q 40/00

(52) U.S. Cl. CPC G06Q 30/04; G06Q 40/12

(57) ABSTRACT

A method and a system for personalized customer dunning, performed by at least one processor. The method includes monitoring a status of a plurality of invoices; obtaining a customer score for a customer corresponding to an invoice of the plurality of invoices, based on the status of the invoice, and wherein the customer score is previously determined based on customer data; receiving customer-specific data via a real time data ingestion pipeline from one or more customer data sources; generating a dunning score for the customer based on the received customer-specific data and the customer score; determining one or more dunning actions, based on the dunning score; performing the one or more dunning actions; and notifying the customer of the performed one or more dunning actions via a first engagement channel.

### FIELD

This disclosure relates to a dunning process performed with real time data in a customer data platform. The dunning process may be customized for individual customers based on real time decision making and each customer's status. This processing takes both the current status of the customer and past customer behavior into consideration when performing an action (for example, barring services, sending a notification, etc.).

### DESCRIPTION OF RELATED ART

In the related art, a telecommunication dunning process is based on system specifications such as days overdue, credit limit, etc. The dunning process has traditionally been a scheduled billing function performed periodically. Some artificial intelligence (AI) and machine learning (ML) has been introduced to segment customers. However, this is also done by batching customers in large segments and may group customers inaccurately.

Traditionally, the dunning process is performed as part of a billing system. This is done in this manner due to payment and billing data being available in the billing system. Since billing is a key business support system (BSS) solution component which involves finances; any changes to the dunning process would have to go through rigorous multilevel testing. Any simple operation, such as changing the dunning process or reconfiguration of dunning policy, would impact the billing system and would need to go through a billing change request process. Additionally, the dunning process may be based on a set of rules executed on a pre-set number of days for all customers. Further, the standard for customer notifications in related art are done via Email and/or SMS.

Therefore, the dunning process in the related art is mainly based on billing status and does not consider real time data (for example, if a card expiration caused a customer to miss a payment). As such, the dunning process in the related art does not take the current customer status or past customer behavior into consideration and thus does not provide accurate dunning actions personalized to an individual customer. Customer engagement is also limited and generalized for all customers. The dunning process, as described in the related art, is also time consuming and costly for the customer and a service operator. For example, when a dunning action such as barring occurs in error, the disappointed customer spends unnecessary time trying to repair the issue.

### SUMMARY

One or more example embodiments of the present disclosure provide a system and a method allowing personalized customer dunning for customers across multiple applications.

According to embodiments, there is provided a method for personalized customer dunning, performed by at least one processor. The method may include monitoring a status of a plurality of invoices; obtaining a customer score for a customer corresponding to an invoice of the plurality of invoices, based on the status of the invoice, and wherein the customer score is previously determined based on customer data; receiving customer-specific data via a real time data ingestion pipeline from one or more customer data sources; generating a dunning score for the customer based on the received customer-specific data and the customer score; determining one or more dunning actions, based on the dunning score; performing the one or more dunning actions; and notifying the customer of the performed one or more dunning actions via a first engagement channel.

According to embodiments, there is provided a system for personalized customer dunning. The system may include at least one memory storing instructions and at least one processor configured to read the program code and operate as instructed by the program code. The program code may include monitoring code configured to cause the at least one processor to monitor a status of a plurality of invoices; obtaining code configured to cause the at least one processor to obtain a customer score for a customer corresponding to an invoice of the plurality of invoices, based on the status of the invoice; and wherein the customer score is previously determined based on customer data; receiving code configured to cause the at least one processor to receive customer-specific data via a real time data ingestion pipeline from one or more customer data sources; first generating code configured to cause the at least one processor to generate a dunning score for the customer based on the received customer-specific data and the customer score; determining code configured to cause the at least one processor to determine one or more dunning actions, based on the dunning score; performing code configured to cause the at least one processor to perform the one or more dunning actions; and notification code configured to cause the at least one processor to notify the customer of the performed one or more dunning actions via a first engagement channel.

According to one or more embodiments, there is provided a non-transitory computer-readable medium storing computer code. The computer code may be configured to, when executed by at least one processor, cause the at least one processor to monitor a status of a plurality of invoices; obtain a customer score for a customer corresponding to an invoice of the plurality of invoices, based on the status of the invoice, and wherein the customer score is previously determined based on customer data; receive customer-specific data via a real time data ingestion pipeline from one or more customer data sources; generate a dunning score for the customer based on the received customer-specific data and the customer score; determine one or more dunning actions, based on the dunning score; perform the one or more dunning actions; and notify the customer of the performed one or more dunning actions via a first engagement channel.

Additional aspects will be set forth in part in the description that follows and, in part, will be apparent from the description, or may be realized by practice of the presented embodiments of the disclosure.

### BRIEF DESCRIPTION OF THE DRAWINGS

The above and other aspects, features, and aspects of embodiments of the disclosure will be more apparent from the following description taken in conjunction with the following accompanying drawings, in which:

FIG. 1 illustrates a diagram of devices of a system, according to one or more embodiments;

FIG. 2 illustrates a diagram of components of the devices of FIG. 1, according to one or more embodiments;

FIG. 3 illustrates an exemplary flowchart of a dunning process, as described in related art;

FIG. 4 illustrates an exemplary flowchart of a dunning process, according to one or more embodiments;

FIG. 5 illustrates an exemplary of an architecture design of the integration between a centralized platform and the surrounding ecosystem, according to one or more embodiments;

FIG. 6 illustrates an example of a 3-tier architecture used by a centralized dunning platform, according to one or more embodiments;

FIG. 7 illustrates a data flow diagram in an ecosystem for performing a dunning process with real time data according to an embodiment;

FIG. $ illustrates a dunning decision flow diagram based on the data flow diagram of FIG. 7 according to an embodiment;

FIG. 9 illustrates an exemplary flowchart of a method for personalized customer dunning, according to one or more embodiments;

FIG. 10 illustrates a block diagram of an example of computer code for personalized customer dunning, according to one or more embodiments; and

FIG. 11 is an example implementation of the dunning process according to an embodiment.

### DETAILED DESCRIPTION

The present disclosure relates to a centralized customer data platform (i.e., centralized in relation to a plurality of applications and data sources) for real time personalized dunning. The centralized customer data platform includes a dunning process which enables creation of a real time dunning score and decision on any dunning engagement in real time by using data from other applications in the ecosystem.

The data used to create the real time dunning score may include dynamic customer specific dunning values which provide more accurate decision making in: dunning engagement, real time access to a customer's latest status before any payment reminder/bill or dunning process is executed, personalized dunning flow based on each customer's attribute rather than using a mass or segmented approach; and customer preferred channel engagement (compared to the standard Email and SMS). The contact delivery may also be tracked. Thus, a reminder or other channel of communication may be triggered based on need.

According to embodiments, the dunning process is moved out of the billing system or a billing platform and moved into the centralized customer data platform. The centralized customer data platform may be used in conjunction with multiple applications and data sources hosted in a system. Each system user of the multiple applications may access the centralized customer data platform to create dunning operations and perform a dunning process customized for each customer of the application.

Apparatuses and methods according to one or more embodiments utilize a centralized dunning platform (for example, built on a microservices architecture) that can obtain customer-specific data from customer data sources over a real time data ingestion pipeline using Kafka streams), Thus, the dunning decision model is removed from the billing platform and is moved into a platform that deploys a decision model that is configurable on-the-fly (i.e., not hardcoded) with access to data that is obtained over a real time data ingestion pipeline. As a result, the centralized dunning platform may deploy a fully customizable dunning decision model configurable by a user to take user-defined dunning actions based on any ofvarious user-specified customer data. Further, because the dunning decision is based (at least in part) on customer-specific data ingested over a real time data pipeline, the dunning decision is not handcuffed to periodically obtained batch customer data.

Embodiments of the present disclosure are described comprehensively with reference to the accompanying drawings. However, the examples of implementations may be implemented in various multiple forms, and the disclosure should not be construed as being limited to the examples described herein, Conversely, the examples of implementations are provided to make the technical solution of the disclosure more comprehensive and complete, and comprehensively convey the idea of the examples of the implementations to a person skilled in the art. The accompanying drawings are merely example illustrations of the disclosure and are not necessarily drawn to scale.

The proposed features discussed below may be used separately or combined in any order. Some block diagrams shown in the accompany drawings are functional entities and do not necessarily correspond to physically or logically independent entities. Further, the embodiments may be implemented by processing circuitry (e.g., one or more processors or one or more integrated circuits) or as computer software using computer-readable instructions and physically stored in one or more computer-readable media, or implemented in different networks and/or processor apparatuses and/or microcontroller apparatuses. In one example, the one or more processors execute computer program code that is stored in a one or more non-transitory computer-readable media.

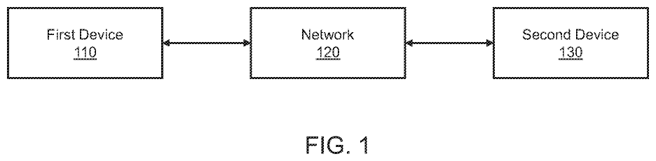

The centralized customer data platform may be accessed through a system via a graphical user interface or the like. FIG. 1 is a diagram of an example system according to an embodiment. FIG. 1 includes a first device 110, a network 120, and a second device 130. The first device 110 and the second device 130 may interconnect via wired connections, wireless connections, or a combination of wired and wireless connections.

The first device 110 may include user devices such as a computing device e.g., a desktop computer, a laptop computer, a tablet computer, a handheld computer, a smart speaker, a server device, etc.), a mobile phone (e.g., a smart phone, a radiotelephone, etc.), a camera device, a wearable device (e.g., a pair of smart glasses or a smart watch), or a similar device.

The second device 130 may include one or more devices. For example, the second device 130 may include one or more of a server device (or at least one server device), a computing device, or the like. The second device 130 may correspond to the centralized customer data platform and/or the one or more applications accessing the centralized customer data platform to perform dunning of one or more embodiments. In an embodiment, the second device 130 may host and deploy the centralized customer data platform in accordance with a microservices architecture.

The network 120 may include one or more wired and/or wireless networks. For example, network 120 may include a cellular network a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional de-vices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) may perform one or more functions described as being performed by another set of devices.

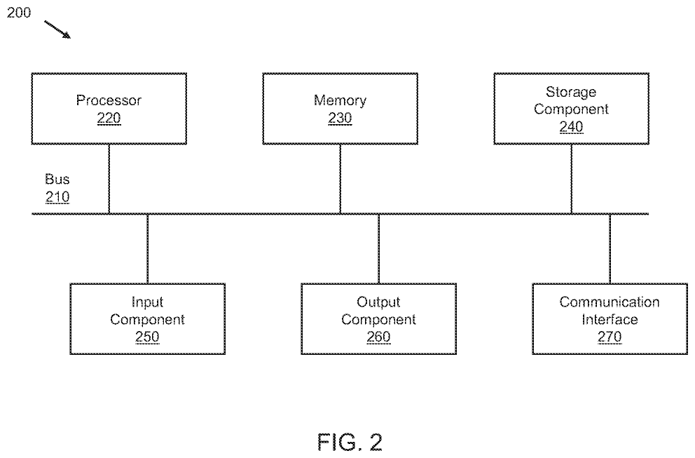

FIG. 2 is a diagram of components of one or more devices of FIG. 1 according to an embodiment, Device 200 may correspond to the first device 110 and/or the second device 130.

As shown in FIG. 2, the device 200 may include a bus 210, a processor 220, a memory 230, a storage component 240, an input component 250, an output component 260, and a communication interface 270.

The bus 210 may include a component that permits communication among the components of the device 200. The processor 220 may be implemented in hardware, software, or a combination of hardware and software. The processor 220 may be a central processing unit (CPU), a graphics processing unit (GOO, an accelerated processing unit (APU), a microprocessor, a microcontroller, a digital signal processor (DSP), a field-programmable gate array (FPGA), an application-specific integrated circuit (ASIC), or another type of processing component. The processor 220 may include one or more processors capable of being programmed to perform a function.

The memory 230 may include a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 may store information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 may include: a component that permits the device 200 to receive information, such as via user input (e.g., a touch screen display, a keyboard, a keypad, a mouse, a button, a switch, and/or a microphone). The input component 250 may include a sensor for sensing information (e.g., a global positioning system (GPS) component, an accelerometer, a gyroscope, and/or an actuator).

The output component 260 may include a component that provides output information from the device 200 (e.g., a display, a speaker, and/or one or more light-emitting diodes (LEDs)).

The communication interface 270 may include a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform operations based on the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or storage component 240 may cause the processor 220 to perform one or more processes described herein.

Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2, Additionally, or alternatively, a set of components (e.g., one or more components) of the device 200 may perform one or more functions described as being performed by another set of components of the device 200.

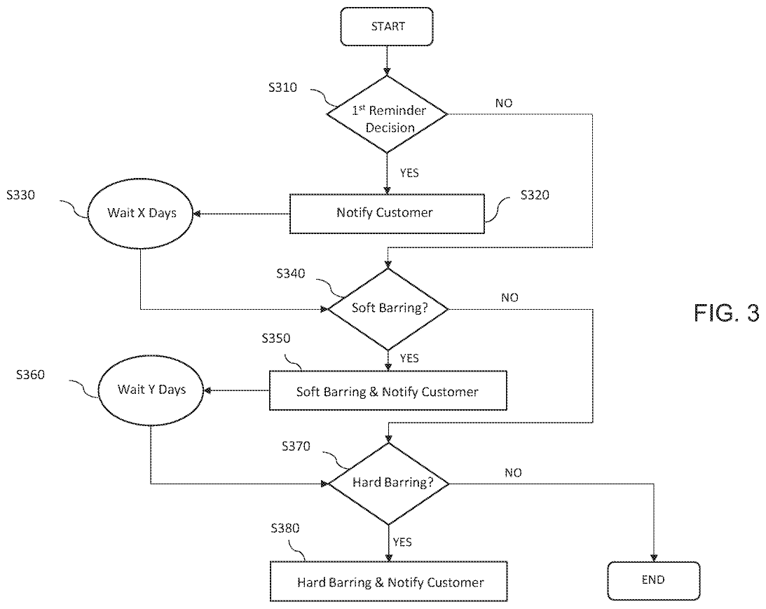

FIG. 3 is an example flowchart of a dunning process 300 in accordance with the related art, The dunning process 300 is a scheduled dunning process based on a set of rules executed on a pre-set number of days for all customers. A list of customers are grouped into segments and the dunning process 300 is performed for each customer in a segment. The list of customers may be segmented on a daily basis.

Referring to FIG. 3, in S310, a decision is made whether to send a first payment reminder to the customer. If the decision at S310 is “YES”, the dunning process 300 proceeds to S320 and a notification with a first payment reminder is sent to the customer. After which, at S330, the dunning process 300 waits a predetermined X number of days. The predetermined X number of days are the same for all customers in the segment. When the predetermined X number of days since the first payment reminder elapses (i.e., the pre-set number of days has passed), a decision is made at S340 whether or not to perform soft barring. If the decision at S310 was not to send a first payment reminder to the customer, the dunning process 300 proceeds to S340 to decide whether or not to perform soft barring. For example, this may be done if a first reminder has previously been sent, immediate soft dunning decision making is required based on the set of rules, etc.

When the decision at S340 is “YES”, the dunning process 300 proceeds to S350 where soft barring is performed and a notification of the soft barring is sent to each of the customers in the segment. For example, the soft barring may include a temporary suspension of some services, a temporary disabling of some features, a temporary downgrading (e.g., throttling) of services, etc. Following the soft barring, at S360, the dunning process 300 waits a predetermined Y number of days (where Y may be equal to or different from X). When the predetermined Y number of days from the notification at S350 elapses, the dunning process 300 proceeds to S370 where a decision is made whether or not to perform hard barring. If the decision at S340 was not to perform soft barring (e.g., if a customer has made a payment and been removed from the segment of customers, soft barring has previously been performed, etc.), the dunning process 300 proceeds to S370 to decide whether or not to perform hard barring. Alternatively, if the customer has made the payment (before S370), then the process would simply end.

When the decision at S370 is “YES”, the dunning process 300 proceeds to S380 where hard barring is performed and a notification of the hard barring is sent to the customers in the segment. The hard barring may include a suspension or cancellation of all services. If the decision at S370 was not to perform hard barring, the dunning process 300 ends. For example, if the customer has made payment, the customer would be removed from a barring list, hard barring would not be performed, and the dunning process would end.

As shown in FIG. 3, the dunning process 300 in the related art is based on due date and payment information and does not take the customer's current status (e.g., real time information on the customer) or past customer behavior into consideration when determining barring. The dunning process 300 is also performed for batch of customers in a segment and therefore is not customized for individual customers.

The techniques for personalized dunning via the centralized customer data platform (hereafter “centralized platform”), according to one or more embodiments, introduces real time event capability and real time decision making for each individual customer. This allows for personalized customer centric dunning actions based on each customer's status while simplifying the dunning process. This approach also allows, if needed, a service operator to quickly make changes or update the dunning process to calibrate based on a customer's past experience while also looking into potential revenue lost.

This more personalized dunning approach would also reduce customer support calls, manage and encourage better experiences during a typically negative task, and minimize revenue leakage.

The centralized platform may be built using a real time technology stack which would provide the capability to execute any decision in real time at each individual customer level. An individualized dunning process may be implemented based on each customer's current status. In particular, the individualized dunning process may make a real time dunning decision based on an offline analytical result and real time data (e.g., real time data ingested by the centralized platform from data sources in real time using Kafka streams). The offline analytical result may include a customer score, which is a quantitative or numerical value that is calculated or determined based on (e.g., as a weighted average of values corresponding to) at least one of, by way of example, the customer's average revenue per user (ARPU), customer type (e.g., VIP status), tenure, and the like. The offline analytical result may also include or factor a fraudulent value score, which may be calculated using a predetermined set of rules to assess a fraud risk. The offline analytical result (e.g., customer score) may be uploaded or provided to the centralized platform periodically, such as on a daily basis.

The real time data, meanwhile, may be pushed to or pulled by the centralized platform in real time (e.g., at the time the dunning decision is made). The real time data may include real time customer data such as information on whether the customer has any open tickets or complaints, a customer's roaming status (which may be indicative of whether the customer is able to receive notifications regarding payment issues or barring decisions based on customer experience), a network performance (e.g., KPI data such as Reference Signal Received Power (RSRP) measurement results with respect to a customer's user equipment or home address), a current bill amount, whether any partial payments have been made, a number of previous notifications to the customers, whether the customer has received and/or read prior notifications, any auto payment failures, whether any other lines on a customer's account (e.g., family account) have been paid, etc. The real time data may be provided by various data sources via a real time data ingestion pipeline e.g., Kafka streams) to the centralized platform.

A real time dunning decision model, which would use both the analytical results (e.g., offline dunning model batch scores) and the real time data, is introduced to the dunning process, according to embodiments. The real time dunning decision model is configured with a set of rules, thresholds, determinations, etc., to calculate a score or make a decision as to a next dunning action. The model itself may vary in various embodiments and may vary based on an operator's preferences. According to an embodiment, a user of the centralized platform (e.g., a registered user of one or more applications hosted by the centralized platform) may configure the model or modify a configuration of the model (e.g., may determine at least one of which real time data to ingest and use as input factors in the decision model, weights to apply to the input factors, actions based on the input factors, thresholds, rules, etc.). For example, the centralized platform may host or deploy an application through which a user may configure a dunning flow and rules constituting the decision model. The configuration may be with respect to customer data stored in a data store or database of the centralized platform, said customer data including batch customer score or analytical score uploads from an analytical framework, and real time customer-specific data obtained via, a real time data ingestion pipeline from customer data sources. In an embodiment, the model makes a decision as to a next action based on both an analytical score and real time data. By using real time data to generate the real time dunning score together with offline analytical data, the dunning process reduces the occurrence of erroneous barring or other dunning actions.

For example, different thresholds (i.e., with respect to real time and/or customer data) for triggering varying dunning actions may be applied for each customer when implementing the dunning process based on the customer's current status. The different thresholds may trigger a combination of dunning actions such as multiple customer reminders, other contact efforts, soft barring, hard barring, etc. In some example embodiment, one customer may hold various devices, or the like, registered in a customer account or in one or more applications. In this case, dunning actions may be performed independently on individual devices belonging to the same customer account. Dunning actions based on customer accounts may also be defined to be triggered) by the different thresholds and thus provide the flexibility of barring at the individual device level compared to barring at the overall account level of the customer.

By way of another example, the real time dunning decision model may be configured to determine not to bar or suspend a customer with a bill amount below a predetermined value. For example, there may not be barring for a bill below $10. Barring may also be delayed for customers who have open tickets regarding, for example, network issues or for customers who are issued a trouble ticket. The centralized platform may also provide some delay in dunning actions (e.g., by increasing the different thresholds) when implementing the dunning process for customers who are roaming.

In the same or another embodiment, the centralized platform may also consider relating customer information when implementing the dunning process. For example, if five customers are related (e.g., their customer accounts fall under a single household or household account), the centralized platform is able to perform barring for the five customers individually and independently.

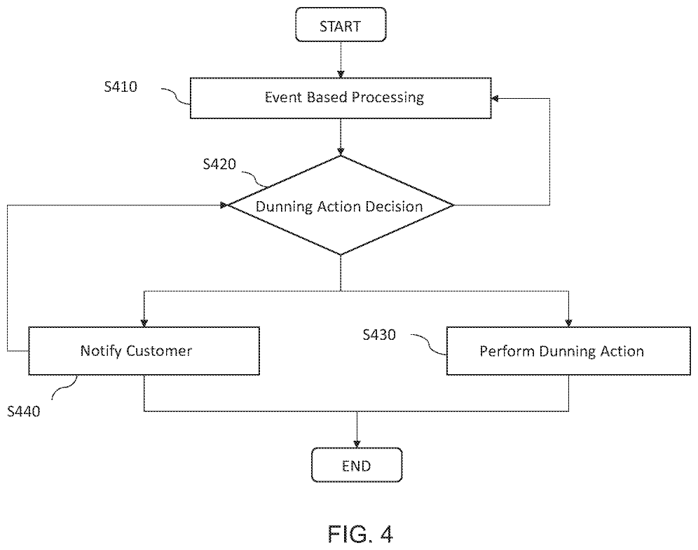

FIG. 4 is an example flowchart of a dunning process 400 of the centralized platform, according to embodiments. As mentioned above, the dunning process 400 is based on real time decision making and a customer's current status. The dunning process 400 may begin processing when a bill/invoice is issued or based on bill information (e.g., due date, bill amount, bill status, etc.), For example, the dunning process 400 may begin when it is determined that a bill is overdue. The dunning process generates a dunning score using both offline analytical results and real time customer data, and may decide on making a dunning action based on the dunning score. A detailed description of this processing is described below with reference to FIG. 4.

Referring to FIG. 4, at S410, the dunning process 400 performs event-based processing. The centralized platform receives billing details and payment details. For example, when a bill is issued, based on bill information (for example, due date, bill amount, bill status, etc.), the bill is continuously or periodically checked for invoices with an overdue status. If an invoice is flagged as overdue, the dunning process retrieves customer data relating to an individual customer (such as the analytical score. The analytical score may include or be determined based on a customer score (as described above) or both of a customer score and a fraud score or risk. The customer score and the fraud score may be based on, for example, a set of rules defined by a system user of the centralized platform. The analytical score may be uploaded to the centralized platform on a periodic basis (e.g., daily) and is used in the dunning process 400 when determining dunning actions.

At S420, the dunning process 400 decides whether to perform dunning actions based on the analytical score or data as well as real time customer data. The determination at S420 retrieves real time customer profile information (e.g., information regarding open tickets associated with the customer, roaming indicators, etc.). Using the retrieved real time data and the analytical data from S410, the dunning score is calculated and considered when making the decision to perform dunning actions. The dunning process 400 may continuously retrieve customer data and customer profile information from multiple applications to generate or update the dunning score. When the decision at S420 is not to perform a dunning action, the dunning process 400 returns back to S410 if dunning actions are not to be performed, the dunning process 400 may, alternatively extend a payment due date of the overdue invoice (without performing dunning actions such as barring). The decision not to perform the dunning action may occur if, for example, a ticket according to the customer profile information indicates that the issue in the ticket relates to a delay in payment. In this case, an extension of the payment due date may be configured in the decision model and barring is not required, Additionally, a dunning action such a payment reminder may not be desired for a valued customer. Thus, an extension of the due date may be configured in the decision model where a customer is a valued customer. Following the extension of the due date, the customer may receive a due date extension notification (at S440) rather than a payment reminder (i.e., dunning action notification). The dunning process 400 may also check for changes in the customers subscription status before performing a dunning action. For example, the subscription status may indicate an updated payment agreement, the need for an extended due date, or the like. When the decision at S420 is to perform dunning actions, based on the dunning score, an appropriate dunning action is determined and the dunning process proceeds to S430-S440.

At S430, the dunning process 400 performs the appropriate dunning action determined from S420. The performed dunning action may include one or more actions, of which one or more may or may not be required. In one example embodiment, all the required dunning actions are executed. In another embodiment, all dunning actions supported by a core BSS API may be executed.

At S440, the customer may be notified of the appropriate dunning action determined from S420 through a preferred channel of engagement. The preferred channel of engagement may be based on channel affinity. The delivery feedback may also be tracked and monitored for future consideration. Based on the delivery feedback (i.e., if the customer received the notification), the dunning process 400 may return back to S420 to, for example, re-notify a customer or end the dunning process 400. In some embodiments, the dunning process 400 schedules some actions, such as reminders, before the due date. The dunning process 400 may also perform a verification process before triggering the customer notification to verify that a payment has not been made, if a reminder has previously been sent, how man reminders have been sent, etc. As shown in FIG. 4, the customer is notified and the dunning action is performed at the same time. Embodiments are not limited to this. For example, the customer may be notified of the dunning action before or after the dunning action is performed.

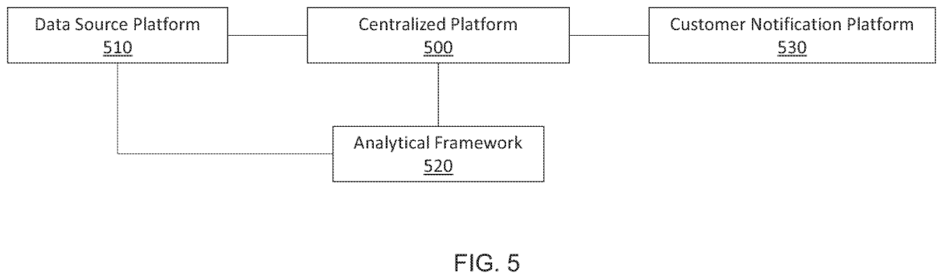

An example, according to one or more embodiments, of a centralized platform 500 for customer centric dunning will now be described with reference to FIG. 5.

FIG. 5 illustrates the integration between the centralized platform 500 and the surrounding ecosystem where all customer interactions are handled in real time. This integration may be done through an open API framework and data streams. The centralized platform 500, as previously described, is a customer centric dunning platform and may be designed and developed using a multi-tier architecture approach which includes at least three logical computing tiers.

As shown in FIG. 5, elements of the integration may include the centralized platform 500, a data source platform 510, an analytical framework 520, and customer notification platform 530.

The centralized platform 500 is the customer centric dunning platform wherein the dunning process may be performed or executed by one or more processors included in the centralized platform 500. Any rule configurations applied to the dunning process for performing the dunning process, other micro-operations, data storage (e.g., for storing customer data storage, customer profile information, etc.), and data management may be included in the centralized platform 500 and accessed by system users through system user portals of the centralized platform 500.

Real time data may be retrieved from the data source platform 510 when performing the dunning process as described. The real time data ingestion capabilities of the centralized platform according to embodiments make the technical solutions of the centralized system possible and enhances the dunning process using the resulting dunning score. The data source platform 510 may provide a copy of the required data to the dunning process (e.g. the dunning process 400) of the centralized platform 500. The data source platform 510 may include or communicate with one or more data sources associated with an application or a systems ithin the ecosystem using the centralized platform 500. For example, the data source platform 510 may include a customer profile information database containing customer data such as open ticket information, a billing platform wherein bills/invoices are generated, network performance, web logs, click streams, etc.

The billing platform provides the dunning process with billing and payment information. The billing platform may also include a barring flag which may be triggered if a decision to perform a dunning action (such as barring) is made. A barring response status may also be provided from the billing platform to the dunning process. Network performance may be used when determining if a dunning action should be performed. For example, if a customer has been experiencing low quality network performance, an extension of an overdue invoice may be preferred over a dunning action.

The data (e.g., payment information) from the data source platform 510 may be used by or sent to the billing platform while the centralized platform 500 uses a copy of the data to perform the dunning process. Examples of data that may be copied to execute the dunning process include open tickets, roaming flags, payment information, history of payment failures, network quality, credit limit and threshold hits, etc.

The centralized platform 500 uses the analytical framework 520 to generate analytical results, such as the customer score, using an AI model. These results may be used to identify a good-faith debtor and any potential debt due to fraudulent activity (e.g., a stolen device). The centralized platform 500 may use the analytical results to generate a predictive fraud score. The centralized platform 500 may use the predictive fraud score, the customer score (or any one or more of the types of analytical scores), in combination with the data received from the data source platform 510, to generate the dunning score. The dunning score is their used for any real time decision making. Examples of data that may impact the dunning score include the customer value, a predetermined fraud score (e.g., previously determined and stored in the data source platform 510), a bad debtor flag (e.g., the bad debtor flag may be applied to a customer with a history of late payments and/or overdue invoices), etc. Analytical results are generated for individual customers. As such, the centralized platform 500, using the data source platform 510 and the analytical framework 520, provides each customer with a personalized dunning score and performs dunning actions based thereof.

As part of the integration, the customer notification platform 530 may be used to notify customers based on their preferred channel of engagement. The channels response (for example, a channel response may indicate the delivery status, such as “no delivery” or “delivered”) may be tracked based on the channel type. Based on the tracking results, the centralized platform 500 may accurately re-try notifying a specific customer with the same channel and may use another channel of engagement to re-notify the customer. Further integration of the centralized platform 500 or the customer notification 530 to a channel affinity model(s) may provide farther information such as a customers preferred language, preferred channel for contact, or preferred contact time and date. The channel affinity model(s) may be based on user behavior and/or preference taken from a marketing platform or other database separate from or included in the centralized platform 500.

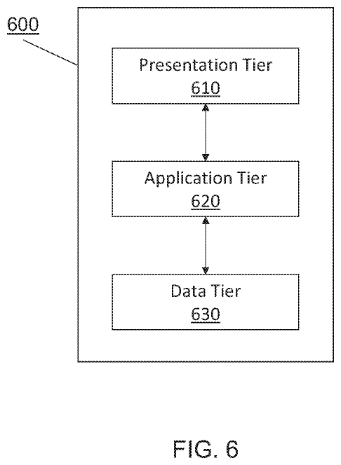

FIG. 6 shows an example of a 3-tier architecture 600 used by the centralized platform 500. As shown in FIG. 6, the 3-tier architecture may include a presentation tier 610, an application tier 620, and a data tier 630. This architecture approach automates the end-to-end dunning process based on customer data. The 3-tier architecture also provides many benefits including security and scalability for production and development environments by modularizing the user interface, business logic, and data storage layers.

The presentation tier 610 is the front-end layer in the 3-tier architecture 600, The presentation tier 610 may include a dunning application portal and customer support GUI for user interfacing. The presentation tier 610 may be built using HTMLS, JavaScript and CSS web technologies and communicate with other layers through an internal and Open API.

The application tier 620 may include the functional business logic which drives the centralized platform's core capabilities. These include all the core applications which may be deployed as micro-services when, for example, executing a dunning process according to embodiments.

The data tier 630 may include a database/data storage system and data access layers. This may include an in-memory No-SQL database and relationship databases which may be used by the application components in the application tier 620. A business users would not directly have access to the data layers in the data tier 630.

In embodiments, user access may be controlled using role-based user assignment with individual login. That is, login information with passwords for each of the users. All logins for different types of users (for example, business user, approver, IT, admin, etc.) are made through a user portal such as, for example, the dunning application portal and the customer support GUI. Therefore, the users would not require any access to the core billing platform to access the dunning process. For example, when login information of a customer support member is made through the user portal, the customer support member would able to access the platform functionality through the user portal to view all the notification and messages which were sent to a customer. If, for example, the login information of an admin is made, the admin would be able to access the application stack through an intranet login access.

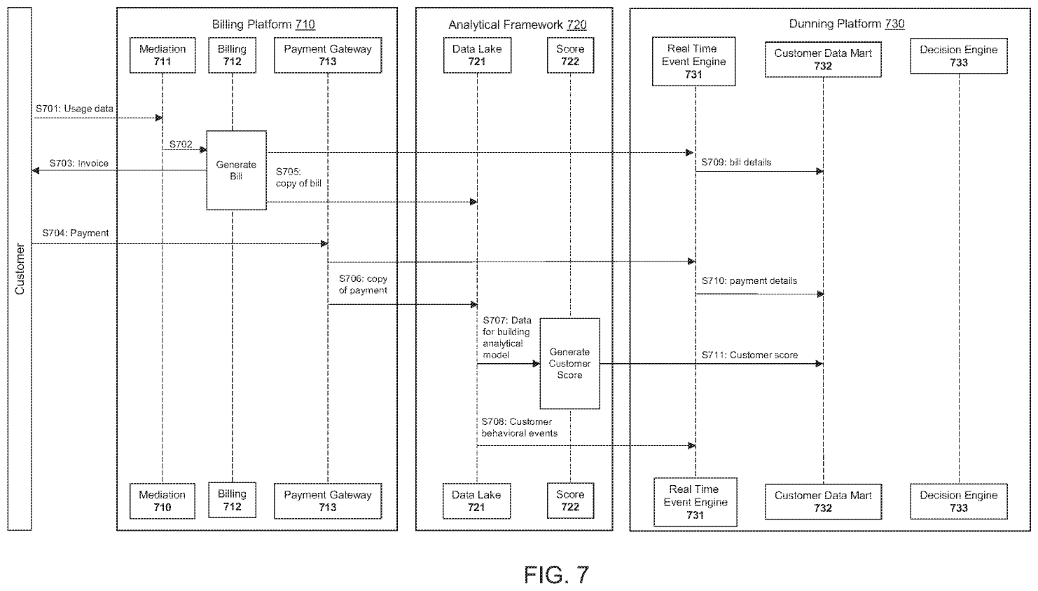

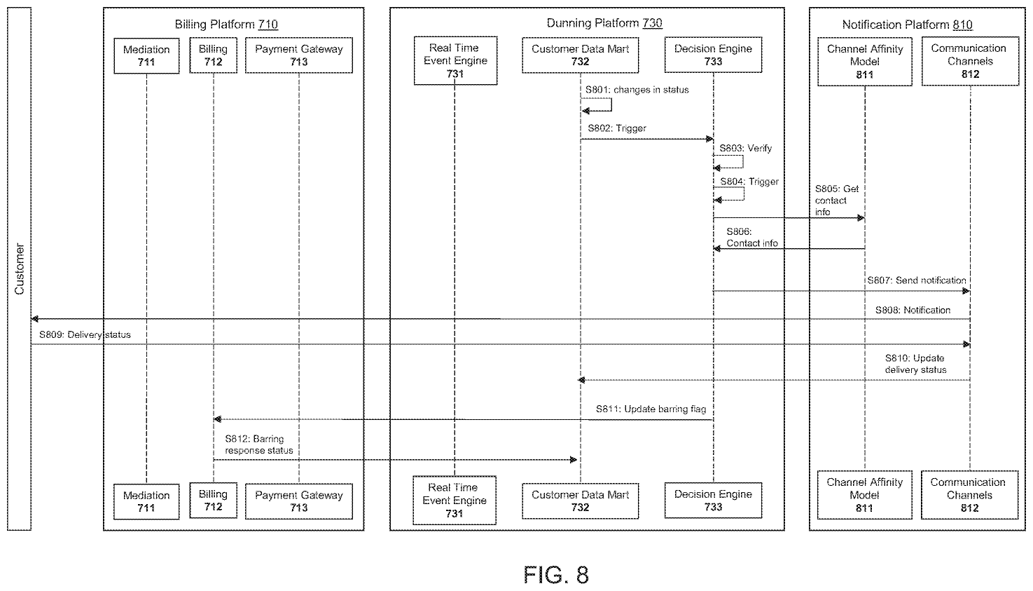

FIG. 7 illustrates a data flow diagram in an ecosystem for performing a dunning process with real time data according to an embodiment. The data flow may be applied to one or more applications (or microservices) hosted by the customer data platform (e.g., the centralized platform 500) as well as other platforms in the ecosystem. As shown in FIG. 7, the data flow diagram includes a billing platform 710, an analytical framework 720, and a dunning platform 730.

The billing platform 710 is a data source for receiving customer specific billing and payment information. The billing platform 710 includes a mediation module 711, billing module and payment gateway module 713. At S701, the mediation module 711 obtains a collection of data records or usage data (e.g., Customer Data Record (CDR)/Even Data. Record (FDR)), based on customer usage of an application or service (from among the one or more applications). FIG. 7 illustrates the usage data obtained from a customer, however, the usage data may be obtained from the one or more applications and not directly from the customer. At S702, the data usage is sent by the mediation module 711 to the billing module 712 for bill generation. The billing module 712 generates a bill and an invoice based on the bill, wherein the invoice is sent by the billing module 712 to the customer thereafter. The invoice may be billed directly to the customer from billing module 712 of the billing platform 710 or through the application of which the customer is using. At S704, payment(s) or payment information (e.g., in response to the invoice) is sent to the payment gateway 713. Thereon, a copy of the bill or bill information may be sent to the analytical framework 720 and the dunning platform 730 (i.e., S705), and a copy of the payment or payment information may be sent to the analytical framework 720 and the dunning platform 730 (i.e., S706).

The analytical framework 720 includes a data lake 721 and a score module 722. The analytical framework 720 may correspond to the analytical framework 520 shown in and described above with reference to FIG. 5. As described above, the analytical framework 520 generates analytical results e.g., customer score) and the dunning process of the centralized platform 500 uses the analytical results to determine dunning actions. Similarly, as shown in FIG. 7, the data lake 721 receives a copy of the bill information and the payment information from the billing module 712 and payment gateway module 713 at S705 and S706, respectively. The score module 722 uses, at S707, the ingested data (e.g., the copy of bill information and payment information) to build and/or update an analytical model. The analytical model is used by the score module 722 to generate the customer score (as described above). The customer score is then sent by the score module 722 to the dunning platform 730 for further processing.

The dunning platform 730 is where the dunning process (e.g., the dunning process 400) is performed. The dunning platform 730 may be a part of the centralized platform 500. The dunning platform 730 includes a real time event engine 731, a Customer Data Mart 732, and a decision engine 733. As shown in FIG. 7, the real time event engine 731 receives a copy of the bill information and payment information from the billing module 712 and payment gateway module 713 at S705 and S706, respectively. At S708, customer specific behavioral events (events associated with or indicative of customer behavior, such as customer's roaming events indicative that the customer is frequently traveling out of the country, network usage indicators, trouble tickets created by the customer in the past, etc.) are sent by the data lake to the real time event engine 731 of dunning platform 730. In the same or other embodiments, the customer specific behavioral events may be updated in real time (i.e., sent to the Customer Data Mart 732). At S709, the Customer Data Mart 732 receives bill details from the real time event engine 731, wherein the bill details are retrieved by the real time event engine 731 from the bill information received from the billing module 712. Further, at S710, the Customer Data Mart 732 receives payment details from the real time event engine 731, wherein the payment details are retrieved by the event engine module 731 from the payment information received from the payment gateway module 713. Even further, at S711, the Customer Data Mart 732 receives the customer score from the score module 722. The bill and payment details are generated by the event engine module 731 based on the copies of the bill and payment information received from the billing platform 710 (at S705 and S706) and may include at least part of the information from the bill and the payment. Based on the data ingested at the Customer Data Mart 732, a dunning decision is made and dunning actions may be performed. A dunning decision flow is described with reference to FIG. 8.

The data flow diagram is not intended to restrict the flow of data to the order described above with reference to FIG. 7. For example, the copy of the bill and payment details may be sent simultaneously, one after the other, upon request from the analytical framework 720 and the dunning platform 730, etc.

FIG. 8 illustrates a dunning decision flow diagram based on the data flow diagram of FIG. 7 according to an embodiment.

Based on the data ingested at the Customer Data Mart 732, as shown in FIG. 7, the decision engine 733 of the dunning platform 730 generated a dunning score. Based on the dunning score, a decision is made by the decision engine 733 as to whether or not to perform dunning actions. Before making the decision, the dunning platform 730, at S801, may check for changes in the customers subscription status. As described above, the subscription status may indicate an updated payment agreement, the need for an extended due date, or the like. When there is a change in the customers subscription status that indicated that a dunning action should not be performed (e.g., customer is a frequent roamer, etc.), the customer data mart 732 of dunning platform 730 may trigger some predetermined action (e.g., extend a billing due date for a set number of days, increase customer credit limit, etc.) without determining a dunning action decision using the decision engine 733. Thus, the dunning platform reduces inessential processing by confirming (i.e., checking the customer subscription status) in real time if the dunning action decision should be initiated. For example, depending on the customer subscription status, the dunning action decision may not be initiated a period of time, predetermined by an administrative user, the system/system user, an application/application user, or the liken.

When, for example, there is no change in the customer subscription status and/or a change that does not affect dunning action decision making, at S802, a trigger is sent by the Customer Data Mart 732 to the dunning decision engine 733. The trigger initiates events for determining the dunning action decision. When the decision is to perform dunning actions, based on the dunning score, an appropriate dunning action is determined by the decision engine 733 and the dunning process continues. The decision engine 733 may verify, at S803, for example, that the determined dunning action is appropriate for the specific customer's situation (e.g., soft barring is performed instead of hard barring for a first missed payment, etc.). In some embodiments, the decision engine 733 may verify that the determined dunning action such as barring execution to the Core BSS platform or extending the payment due date is successfully performed.

At S804, after the verification at S803 is completed, a customer notification trigger initiates a customer notification(s). At S805, a request for customer contact information is sent to the notification platform 810. Specifically, the request is sent to the channel affinity model 811. The notification platform 810 may correspond to the customer notification platform 530 shown in and described above with reference to FIG. 5.

At S806, the channel affinity model 811 sends the requested contact information to decision engine 733. At S807, a request from the decision engine 733 is sent to the communication channels module 812 to send a notification to the customer based on a channel for engagement selected by the decision engine 733 based on the contact information, At S808, the notification of the dunning action is sent by the communication channels module 812 to the customer via the selected channel for engagement. The delivery status of the notification is sent to the communication channels module 812. The communication channels module 812 also sends the delivery status of the notification to the Customer Data Mart 732.

If barring is performed, based on the dunning action decision made by the decision engine 733, the dunning decision flow may proceed to S811 and S812. At S811, the decision engine 733 send a request to the billing module 712 to update a barring flag in the billing module 712. Following the barring flag update, a response of the barring status (e.g., barring flag update) may be sent from the billing module 712 to the Customer Data Mart 732. In this manner, the dunning platform 730 may consider a response from the billing platform 710 (e.g., “barring unsuccessful”) when determining and/or updating the customer score.

The dunning decision flow diagram is not intended to restrict the process to the above described with reference to FIG. 8. Modifications and variations are possible in light of the above disclosure or may be acquired from practice of the implementations.

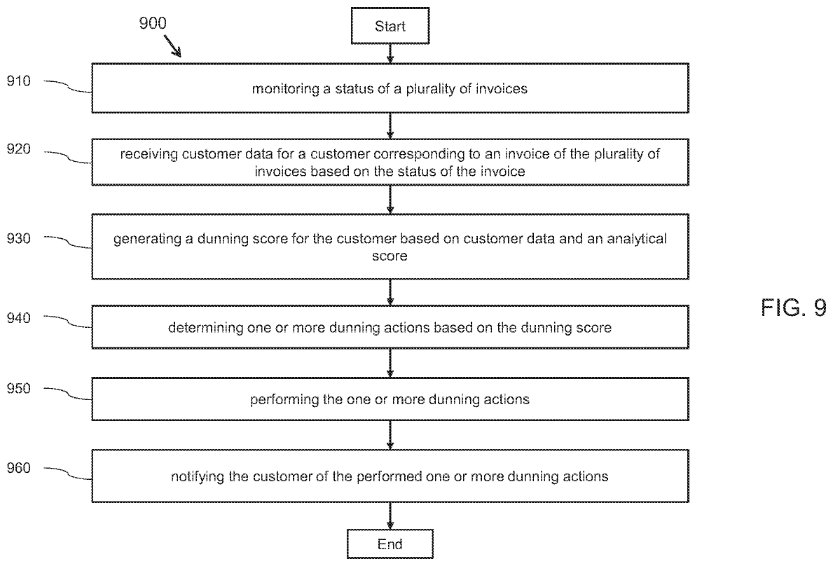

FIG. 9 is an exemplary flowchart illustrating a method 900 for personalized customer dunning, according to one or more embodiments.

As shown in FIG. 9, in operation 910, the method 900 may include monitoring a status of a plurality of invoices.

In operation 920, the method 900 may include receiving customer data for a customer corresponding to an invoice of the plurality of invoices based on the status of the invoice. The customer data includes payment information, customer profile information, open ticket information, etc. The customer data may be retrieved in real time.

In operation 930, the method 900 may include generating a dunning score for the customer based on customer data and an analytical score. The dunning score may be triggered to be calculated, for example, when the status of the invoice is overdue or a predetermined amount of time until or after a due date of the invoice. The method 900 may further include generating a fraud score used to distinguish the customer from a good faith debtor and a customer with fraudulent activity on the invoice.

In operation 940, the method 900 may include determining one or more dunning actions, based on the dunning score, using a decision making model. The decision making model may be performing real time data processing.

In operation 950, the method 900 may include performing the one or more dunning actions. The dunning action may be one of a soft barring, a hard barring, an extension of time, delayed barring, a reminder, etc.

In operation 960, the method 900 may include notifying the customer of the performed one or more dunning actions via an engagement channel. The engagement channel may be a preferred channel of engagement determined based on the customer's behavior.

The method 900 may also include tracking a status of a channel response of the engagement channel based on a channel type. Based on the status, the method 900 may change the channel type to another engagement channel and notify (or re-notify) the customer of the one or more dunning actions via the other engagement channel. This process of notification may be repeated until the status of the channel response is satisfactory.

Although FIG. 9 shows example blocks of the method, in some implementations, the method may include additional blocks, fewer blocks, different blocks, or differently arranged blocks than those depicted in FIG. 9. Additionally, or alternatively, two or more of the blocks of the method may performed in parallel.

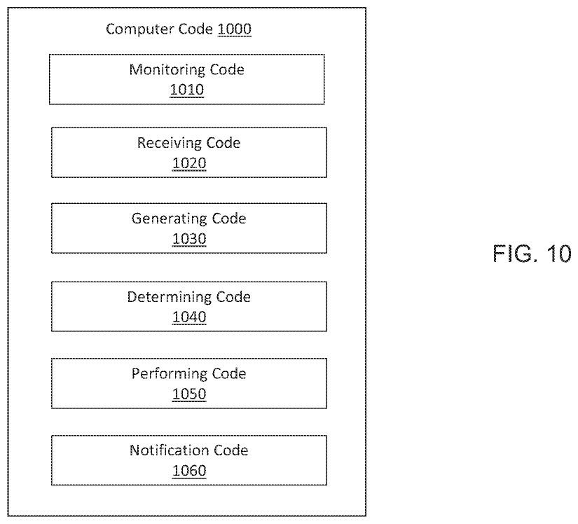

FIG. 10 is a block diagram of an example of computer code for personalized customer dunning, according to one or more embodiments.

According to embodiments of the present disclosure, at least one processor with memory storing computer code may be provided. The computer code may be configured to, when executed by the at least one processor, perform any number of aspects of the present disclosure.

As shown in FIG. 10, the computer code 1000 may include monitoring code 1010, receiving code 1020, generating code 1030, determining code 1040, performing code 1050, and notification code 1060.

The monitoring code 1010 may be configured to cause the at least one processor to monitor a status of a plurality of invoices for one or more applications.

The receiving code 1020 may be configured to cause the at least one processor to receive customer data for a customer corresponding to an invoice of the plurality of invoices based on the status of the invoice, and wherein the customer data includes payment information and customer profile information.

The generating code 1030 may be configured to cause the at least one processor to generate a dunning score for the customer based on customer data and an analytical score.

The determining code 1040 may be configured to cause the at least one processor to determine one or more dunning actions, based on the dunning score, using a decision making model. The decision making model may be performing real time data processing.

The performing code 1050 may be configured to cause the at least one processor to perform the one or more dunning actions.

The notification code 1060 may be configured to cause the at least one processor to notify the customer of the performed one or more dunning actions via a first engagement channel.

Although FIG. 10 shows example blocks of the computer code 1000 of a system or device according to embodiments, in some implementations, the system may include additional blocks, fewer blocks, different blocks, or differently arranged blocks than those depicted in FIG. 10. Additionally, or alternatively, two or more of the blocks of the system may be combined. In other words, while FIG. 10 shows distinct blocks of code, the various code instructions need not be distinct and could be intermingled.

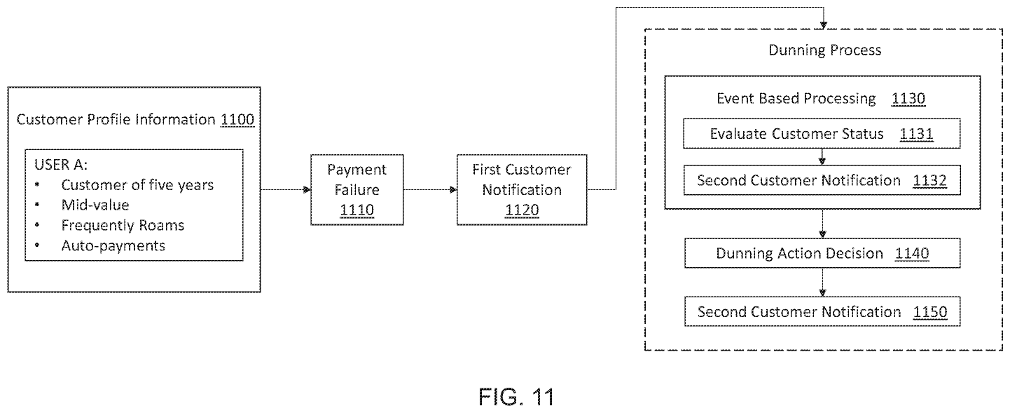

FIG. 11 is a specific example implementation of the dunning process according to an embodiment.

Customer profile information is retrieved from, for example, the data source platform 510 and may be used when determining dunning actions in the dunning process (e.g., dunning process 400). As shown in FIG. 11, according to the customer profile information 1100, User A is a customer of Application 1 for the last five years, a mid-value customer, frequently roams, and has signed up for auto-payments. The example described will be implemented using the customer profile information 1110. The dunning actions or described process are examples and are not intended to limit the scope of the disclosure. One of ordinary skill may reasonably understand that other actions or steps described in the present disclosure may also apply.

In this example embodiment, User A's auto-payment transaction did not go through. As such, the system notes a payment failure 1110 and the User A is notified of the failed transaction through a first customer notification 1120 (e.g., a first SMS, etc.).

In this example, User A is not currently in the country and therefore has not responded to the first customer notification 1120 and misses the payment due date, Now, User A is flagged as part of the dunning process. Subsequently, event based processing 1130 is performed. During the event based processing 1130, customer status is evaluated (i.e., evaluate customer status 1131) and it is determined that User A has been using his/her device while roaming and has reached 90% of the account credit limit. Thus, User A is notified of the current credit limit status through a second customer notification 1132 (e.g., a second SMS, etc.). Based on customer profile information 1100, the dunning process re-evaluates User A's current status (i.e., roaming indicators) and past behaviors (i.e., credit risk) and a dunning action decision 1140 is determined. The decision is determined not to perform barring because User A is a long standing customer of five years, mid-valued, and has roaming indicators. Therefore, as the dunning action, the dunning process automatically implements an increase in User A's credit limit and extends the payment due date. As such, User A has avoided any service barring at this juncture.

Following the dunning action, User A is notified of the increase in credit limit and the payment due date extension through a third customer notification 1150 (e.g., a third SMS and a mobile push notification. Further, a reminder email regarding the extended due date is also sent to User A. The dunning process sends the third customer notification 1150 using various channels of engagement because, for example, the customer is roaming and may not receive the SMS. User A views the third customer notification 1150 and makes the necessary arrangements to process his bill payment by the extended due date. The varying channels of customer engagement may be set and/or pre-set by the administrative user, the system/system user, the application/application user, or the like. Additionally, the system may choose to contact the customer based on a preferred channel of engagement through, for example, the customer notification platform 530. The customer contact may also a combination thereof. For example, the first notification may be via SMS and set by the system user and any subsequent notification may be made based on a channel determined to be the customers preferred channel of engagement.

Although FIG. 11 shows example blocks of a dunning process according to embodiments, in some implementations, the process may include additional blocks, fewer blocks, different blocks, or differently arranged blocks than those depicted in FIG. 11, Additionally, or alternatively, two or more of the blocks of the system may be combined. In other words, while FIG. 11 shows distinct blocks, the various steps in the process need not be distinct and could be intermingled. It is also understood that FIG. 11 provides a specific use case or example of methods described in present disclosure and is not intended to limit the implementations to those described with reference to FIG. 11.

The foregoing disclosure also provides other illustrations and descriptions, but is not intended to be exhaustive or to limit the implementations to the precise form disclosed. Modifications and variations are possible in light of the above disclosure or may be acquired from practice of the implementations.

Some embodiments may relate to a system including at least one memory configured to store computer program code and at least one processor configured to access the computer program code and operate as instructed by the computer program code, a method, and/or a computer readable medium at any possible technical detail level of integration. The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, software instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer readable media according to various embodiments. In this regard, each block in the block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the figures. In some alternative implementations, the functions noted in the blocks may occur out of the order noted in the figures. For example, two blocks shown in succession may, in fact, be executed concurrently or substantially concurrently, or the blocks may sometimes be executed in the reverse order, depending upon the functionality involved. It will also be noted that each block of the block diagrams, and combinations of blocks in the block diagrams, can be implemented by special purpose hardware-based systems that perform the specified functions or acts or carry out combinations of special purpose hardware and computer instructions.

It will be apparent that systems and/or methods, described herein, may be implemented in different forms of hardware, software, or a combination of hardware and software. The actual specialized control hardware or software code used to implement these systems and/or methods is not limiting of the implementations, Thus, the operation and behavior of the systems and/or methods were described herein without reference to specific software code it being understood that software and hardware may be designed to implement the systems and/or methods based on the description herein.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The descriptions of the various aspects and embodiments have been presented for purposes of illustration, but are not intended to be exhaustive or limited to the embodiments disclosed. Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for personalized customer dunning, performed by at least one processor and comprising:
monitoring a status of a plurality of invoices;
obtaining a customer score for a customer corresponding to an invoice of the plurality of invoices, based on the status of the invoice; and wherein the customer score is previously determined based on customer data;
receiving customer-specific data via a real time data ingestion pipeline from one or more customer data sources;
generating a dunning score for the customer based on the received customer-specific data and the customer score;
determining one or more dunning actions, based on the dunning score;
performing the one or more dunning actions; and
notifying the customer of the performed one or more dunning actions via a first engagement channel.

2. The method of claim 1, wherein the customer specific data comprises information on at least one of whether the customer has any open customer service tickets, a roaming status of the customer, a current bill amount, network performance data, whether any partial payments have been made, a number of previous notifications to the customer, whether the customer has received and/or read a prior notification, any auto payment failure, and whether any other lines on an account of the customer have been paid.

3. The method of claim 1, wherein the dunning action is one of a soft barring, a hard barring, an extension of time, delayed barring, and a reminder.

4. The method of claim 1, wherein the first engagement channel is a preferred channel of engagement determined based on customer behavior.

5. The method of claim 1, wherein the dunning score is only calculated when a status of the invoice is overdue.

6. The method of claim 1, further comprising:
generating a fraud score,
wherein the fraud score distinguishes the customer from a good faith debtor and a customer with fraudulent activity on the invoice, and
wherein the generating the dunning score comprises generating the dunning score based on the fraud score.

7. The method of claim 1, further comprising:
tracking a status of a channel response of the first engagement channel based on a channel type;
changing the channel type to a second engagement channel based on the status of the channel response being unsuccessful; and
notifying the customer of the one or more dunning actions via the second engagement channel.

8. A system for personalized customer dunning, the system comprising:
at least one memory configured to store program code; and
at least one processor configured to read the program code and operate as instructed by the program code, the program code including:
monitoring code configured to cause the at least one processor to monitor a status of a plurality of invoices;
obtaining code configured to cause the at least one processor to btain a customer score for a customer corresponding to an invoice of the plurality of invoices, based on the status of the invoice, and wherein the customer score is previously determined based on customer data;
receiving code configured to cause the at least one processor to receive customer-specific data via a real time data ingestion pipeline from one or more customer data sources;
first generating code configured to cause the at least one processor to generate a dunning score for the customer based on the received customer-specific data and the customer score;
determining code configured to cause the at least one processor to determine one or more dunning actions, based on the dunning score;
performing code configured to cause the at least one processor to perform the one or more dunning actions; and
notification code configured to cause the at least one processor to notify the customer of the performed one or more dunning actions via a first engagement channel.

9. The system of claim 8, wherein the customer specific data comprises information on at least one of whether the customer has any open customer service tickets, a roaming status of the customer, a current bill amount, network performance data, whether any partial payments have been made, a number of previous notifications to the customer, whether the customer has received and/or read a prior notification, any auto payment failure, and whether any other lines on an account of the customer have been paid.

10. The system of claim 8, wherein the dunning action is one of a soft barring, a hard barring, an extension of time, delayed barring, and a reminder.

11. The system of claim 8, wherein the first engagement channel is a preferred channel of engagement determined based on customer behavior.

12. The system of claim 8, wherein the dunning score is only calculated when a status of the invoice is overdue.

13. The system of claim 8, the program code further including second generating code configured to cause the at least one processor to generate a fraud score, wherein the fraud score distinguishes the customer from a good faith debtor and a customer with fraudulent activity on the invoice.

14. The system of claim 8, the program code further including:
tracking code configured to cause the at least one processor to track a status of a channel response of the first engagement channel based on a channel type;
updating code configured to cause the at least one processor to change the channel type to a second engagement channel based on the status of the channel response being unsuccessful; and
notifying code configured to cause the at least one processor to notify the customerof the one or more dunning actions via the second engagement channel.

15. A non-transitory computer readable medium storing instructions, the instructions comprising: one or more instructions that, when executed by at least one processor of a system for personalized customer dunning storing instructions that, cause the at least one processor to:
monitor a status of a plurality of invoices;
obtain a customer score for a customer corresponding to an invoice of the plurality of invoices, based on the status of the invoice; and wherein the customer score is previously determined based on customer data;
receive customer-specific data via a real time data ingestion pipeline from one or more customer data sources;
generate a dunning score for the customer based on the received customer-specific data and the customer score;
determine one or more dunning actions, based on the dunning score;
perform the one or more dunning actions; and
notify the customer of the performed one or more dunning actions via a first engagement channel.

16. The non-transitory computer readable medium of claim 1, wherein the customer specific data comprises information on at least one of whether the customer has any open customer service tickets, a roaming status of the customer, a current bill amount, network performance data, whether any partial payments have been made, a number of previous notifications to the customer, whether the customer has received and/or read a prior notification, any auto payment failure, and whether any other lines on an account of the customer have been paid.

17. The non-transitory computer readable medium of claim 15, wherein the dunning action is one of a soft barring, a hard barring, an extension of time, delayed barring, and a reminder.

18. The non-transitory computer readable medium of claim 15, wherein the first engagement channel is a preferred channel of engagement determined based on customer behavior.

19. The non-transitory computer readable medium of claim 15, wherein the instructions further cause the at least one processor to generate a fraud score, wherein the fraud score distinguishes the customer from a good faith debtor and a customer with fraudulent activity on the invoice.

20. The non-transitory computer readable medium of claim 15, wherein the instructions further cause the at least one processor to:
track a status of a channel response of the first engagement channel based on a channel type;
change the channel type to a second engagement channel based on the status of the channel response being unsuccessful; and
notify the customer of the one or more dunning actions via the second engagement channel.
